(19) United States
(12) Patent Application Publication
(10) Pub. No.: US 2024/0239651 A1
(43) Pub. Date: Jul. 18, 2024

(54) INDUSTRIAL, COMMERCIAL AND RESIDENTIAL HYDROGEN GAS PRODUCTION, STORAGE AND CONVERSION SYSTEM

(71) Applicant: Robert John McKENZIE, Calgary (CA)

(72) Inventor: Robert John McKENZIE, Calgary (CA)

(21) Appl. No.: 18/155,091

(22) Filed: Jan. 17, 2023

(51) Int. Cl. C01B 3/06; C01B 3/50

(52) U.S. Cl. CPC C01B 3/06; C01B 3/503; C01B 2203/0277; C01B 2203/0405; C01B 2203/0872; C01B 2203/1017; C01B 2203/1609; C01B 2210/0012

(57) ABSTRACT

An industrial, commercial and residential Hydrogen production and conversion system is provided. The Hydrogen production and conversion system includes a reactor vessel for facilitating the production of Hydrogen gas and Oxygen gas, a separator vessel for separating the produced Hydrogen and Oxygen gas, a Hydrogen receiver vessel for receiving the separated Hydrogen gas, a compressor for compressing the received Hydrogen gas and a Hydrogen storage vessel for storing the compressed Hydrogen gas and providing the stored Hydrogen gas to one or more power systems to be used as fuel.

### FIELD OF THE INVENTION

The present disclosure relates to a Hydrogen gas production, storage and conversion system, more specifically, but not by way of limitation, more particularly to a system of Hydrogen gas production, storage and distribution into industrial, commercial and residential power systems for providing on demand energy generation from non-greenhouse gas emitting energy resources.

### BACKGROUND

Any discussion of the related art throughout the specification should in no way be considered as an admission that such related art is widely known or forms part of common general knowledge in the field.

C.A. Pub. No. 2,770,530 A1 (Wang et al.) discloses embodiments relate to methods of generating hydrogen including contacting magnesium and silicon to form a mixture and reacting the mixture with an aqueous solution, sufficient to generate hydrogen. The solution can include water and salt. Shortcomings include an inability to be designed to receive, store and convert water soluble nanoparticle pellets into Hydrogen and Oxygen gas, to safety separates the Hydrogen and Oxygen gas, to vent out the produced Oxygen gas, to compress and cool the produced Hydrogen gas, to safely store the compressed Hydrogen gas and provide readily available distribution to one or more power systems through non-greenhouse gas emitting energy resources.

J.P. Pub. No. 2011/236107 A (Takeshi) discloses a silicon powder composition for hydrogen generation capable of generating hydrogen by contact with water and a method for producing the silicon powder composition for hydrogen generation, and to establish, utilizing solar energy as starting energy, an energy system which is capable of storage, transportation and circulation by using silicon, and in which carbon dioxide is not discharged from fossil fuels. The silicon powder composition for hydrogen generation which includes a silicon powder, a material containing a metal element capable of forming a silicate having a solubility in water of ≤1%, and a basic material is brought into contact with water to mildly generate hydrogen, and in which the generated hydrogen is then converted into energy. The silicon powder composition for hydrogen generation is preferably obtained by converting silicon dioxide into silicon with a reducing agent such as charcoal or wood waste using electric energy generated from energy originating in solar energy, and by mixing the resulting silicon with sodium hydroxide and calcium hydroxide. The solar energy utilization system utilizing the silicon powder composition for hydrogen generation includes: bringing the silicon powder composition for hydrogen generation into contact with water to generate hydrogen; converting the generated hydrogen into energy; subjecting silicon oxide hydrate containing sodium and calcium produced in hydrogen generation to neutralization with hydrochloric acid, to separate it into silicon oxide hydrate, sodium chloride and an aqueous solution of calcium chloride by water washing; electrolyzing sodium chloride and the aqueous solution of calcium chloride to separate them into sodium hydroxide, calcium hydroxide, chlorine and hydrogen; and producing hydrochloric acid by reacting chlorine and hydrogen. Shortcomings include an inability to be designed to receive, store and convert water soluble nanoparticle pellets into Hydrogen and Oxygen gas, to safety separates the Hydrogen and Oxygen gas, to vent out the produced Oxygen gas, to compress and cool the produced Hydrogen gas, to safely store the compressed Hydrogen gas and provide readily available distribution to one or more power systems through non-greenhouse gas emitting energy resources.

U.S. Pub. No. 2015/0321911 A1 (Jin) discloses a silicon powder composition, method, reactor and device for producing hydrogen. Silicon powder composition includes silicon powder, precipitation agent and alkaline substance; wherein alkaline substance is a weak acid salt of alkali metal; mass ratio of alkaline substance to silicon powder is greater than or equal to 0.06:1 and less than or equal to 4:1; silicon powder is a silicon powder with average particle diameter of less than or equal to 1 mm; molar stoichiometric ratio of precipitation agent to silicon in the silicon powder is greater than or equal to 0.12:1 and less than or equal to 4:1. Also presented is a method and reactor for producing hydrogen, and reaction device for producing hydrogen. Silicon powder composition of invention is an optimized formulation which needs no pre-treatment, contains no highly corrosive alkalis, and does not easily burn or explode. Reactor structure and device of invention have relatively high practicability. Shortcomings include an inability to be designed to receive, store and convert water soluble nanoparticle pellets into Hydrogen and Oxygen gas, to safety separates the Hydrogen and Oxygen gas, to vent out the produced Oxygen gas, to compress and cool the produced Hydrogen gas, to safely store the compressed Hydrogen gas and provide readily available distribution to one or more power systems through non-greenhouse gas emitting energy resources.

W.O. Pub. No. 2008/094840 A2 (Paggi et al.) discloses compositions that include various silicon-based compounds such as polysilanes, layered polysilanes, organosilanes or siloxenes, that are used to generate hydrogen. Methods and devices for generating hydrogen are also disclosed, including those directed to the processes of generating hydrogen for fuel cells or as a supplementary fuel for internal combustion engines. Shortcomings include an inability to be designed to receive, store and convert water soluble nanoparticle pellets into Hydrogen and Oxygen gas, to safety separates the Hydrogen and Oxygen gas, to vent out the produced Oxygen gas, to compress and cool the produced Hydrogen gas, to safely store the compressed Hydrogen gas and provide readily available distribution to one or more power systems through non-greenhouse gas emitting energy resources.

W.O. Pub. No. 2019/158941 A1 (Ivanov et al.) discloses an uncoated pellet, the uncoated pellet comprises silicon and a dispersant and wherein the dispersant has a heat of solution of less than −20 kJ mol-1 and/or the solubility of the dispersant is greater than 40 g/100 ml in water (20° C.). Shortcomings include an inability to be designed to receive, store and convert water soluble nanoparticle pellets into Hydrogen and Oxygen gas, to safety separates the Hydrogen and Oxygen gas, to vent out the produced Oxygen gas, to compress and cool the produced Hydrogen gas, to safely store the compressed Hydrogen gas and provide readily available distribution to one or more power systems through non-greenhouse gas emitting energy resources.

W.O. Pub. No. 2020/245720 A1 (Fourgeot et al.) discloses a composition for producing hydrogen by decomposition of water. This composition contains a silicon powder and it has the particular feature that it comprises at least one additive selected from cellulose derivatives. The invention also relates to a kit for producing hydrogen and to a method for producing hydrogen. Shortcomings include an inability to be designed to receive, store and convert water soluble nanoparticle pellets into Hydrogen and Oxygen gas, to safety separates the Hydrogen and Oxygen gas, to vent out the produced Oxygen gas, to compress and cool the produced Hydrogen gas, to safely store the compressed Hydrogen gas and provide readily available distribution to one or more power systems through non-greenhouse gas emitting energy resources.

W.O. Pub. No. 2022/029408 A1 (Alexandrou et al.) discloses a pellet comprises a milled mixture of silicon 21 and dispersant, wherein the milled mixture 21 comprises particles with a mean diameter of at least 1 micron. Shortcomings include an inability to be designed to receive, store and convert water soluble nanoparticle pellets into Hydrogen and Oxygen gas, to safety separates the Hydrogen and Oxygen gas, to vent out the produced Oxygen gas, to compress and cool the produced Hydrogen gas, to safely store the compressed Hydrogen gas and provide readily available distribution to one or more power systems through non-greenhouse gas emitting energy resources.

U.S. Pat. No. 6,582,676 B2 (Chaklader) discloses a method of producing Hydrogen by reacting a metal selected from the group consisting of Aluminum (Al), Magnesium (Mg), Silicon (Si) and Zinc (Zn) with water in the presence of an effective amount of a catalyst at a pH of between 4 and 10 to produce Hydrogen. The catalyst or other additive is selected to prevent or slow down deposition of the reaction products on the (impair reactions with the) metal that tend to passivate the metal and thereby facilitates the production of said Hydrogen. Shortcomings include an inability to be designed to receive, store and convert water soluble nanoparticle pellets into Hydrogen and Oxygen gas, to safety separates the Hydrogen and Oxygen gas, to vent out the produced Oxygen gas, to compress and cool the produced Hydrogen gas, to safely store the compressed Hydrogen gas and provide readily available distribution to one or more power systems through non-greenhouse gas emitting energy resources.

U.S. Pat. No. 9,011,572 B1 (Bunker et al.) discloses a method of generating hydrogen gas from the reaction of stabilized aluminum nanoparticles with water is provided. The stabilized aluminum nanoparticles are synthesized from decomposition of an alane precursor in the presence of a catalyst and an organic passivation agent, and exhibit stability in air and solvents but are reactive with water. The reaction of the aluminum nanoparticles with water produces a hydrogen yield of at least 85%. Shortcomings include an inability to be designed to receive, store and convert water soluble nanoparticle pellets into Hydrogen and Oxygen gas, to safety separates the Hydrogen and Oxygen gas, to vent out the produced Oxygen gas, to compress and cool the produced Hydrogen gas, to safely store the compressed Hydrogen gas and provide readily available distribution to one or more power systems through non-greenhouse gas emitting energy resources.

U.S. Pat. No. 9,751,759 B2 (Foord et al.) discloses the use of non-passivated silicon to produce hydrogen, by hydrolysis of the non-passivated silicon. In particular, the invention relates to a composition comprising non-passivated silicon, a process for producing a composition comprising non-passivated silicon, and a process for producing hydrogen by reacting the composition with water. Shortcomings include an inability to be designed to receive, store and convert water soluble nanoparticle pellets into Hydrogen and Oxygen gas, to safety separates the Hydrogen and Oxygen gas, to vent out the produced Oxygen gas, to compress and cool the produced Hydrogen gas, to safely store the compressed Hydrogen gas and provide readily available distribution to one or more power systems through non-greenhouse gas emitting energy resources.

All documents cited herein are incorporated by reference.

It is clear that there exists a need for a Hydrogen gas production, storage and conversion system for straightforward Hydrogen gas production, safe Hydrogen gas storage and readily available Hydrogen gas distribution into industrial, commercial and residential power systems for providing on demand energy generation from non-greenhouse gas emitting energy resources. There is need for a Hydrogen production, storage and conversion system that is designed to receive, store and convert water soluble nanoparticle pellets into Hydrogen and Oxygen gas, that safety separates the Hydrogen and Oxygen gas, that vents out the produced Oxygen gas, that compresses and cools the produced Hydrogen gas, that safely stores the compressed Hydrogen gas and provides readily available distribution to one or more power systems through non-greenhouse gas emitting energy resources.

### BRIEF SUMMARY

It is an object of the invention to provide an industrial, commercial and residential Hydrogen production and conversion system.

In accordance with an aspect of the invention, there is provided a system for producing, storing and converting Hydrogen gas into a readily available fuel, the system comprising a reactor vessel for facilitating production of Hydrogen and Oxygen gas, a separator vessel for separating the produced Hydrogen and Oxygen gas, a Hydrogen receiver vessel for receiving the separated Hydrogen gas, a compressor for compressing the received Hydrogen gas and a Hydrogen storage vessel for storing the compressed Hydrogen gas. The reactor vessel comprising a Hydrogen and Oxygen outlet out next to a first pellet inlet on a top of the reactor vessel, a water inlet along a side of the reactor vessel, a motor mount with impeller shaft at a mid-point of the reactor vessel and an impeller within a center of an interior of the reactor vessel attached to the motor mount with impeller shaft, wherein the Hydrogen and Oxygen outlet is employed for transferring the produced Hydrogen and Oxygen gas out from the reactor vessel, wherein the first pellet inlet is employed for receiving a plurality of pellets into an interior of the reactor vessel, wherein the water inlet is employed for receiving water the interior of the reactor vessel and wherein the impeller is coupled to the motor mount with impeller shaft is employed to continually agitate the plurality of pellets and the water. The separator vessel comprising a first Hydrogen outlet on a top of the separator vessel, a semi-permeable membrane within an interior of the separator vessel, an Oxygen outlet on a first side of the separator vessel below the semi-permeable membrane and a mixed gas inlet a second side of the separator vessel, wherein the semi-permeable membrane is employed for separating the produced Hydrogen and Oxygen gas onto either side of the semi-impermeable membrane, wherein the first Hydrogen outlet is employed for transferring the separated Hydrogen gas out from the separator vessel, wherein the Oxygen outlet is employed for transferring the separated Oxygen gas out from the separator vessel, wherein the mixed gas inlet is employed for receiving the produced Hydrogen and Oxygen gas into the interior of the separator vessel and wherein the mixed gas inlet is coupled to the Hydrogen and Oxygen outlet from the reactor vessel. The Hydrogen receiver vessel comprising an emergency vent on a top of the Hydrogen receiver, a second Hydrogen outlet along a first side of the Hydrogen receiver vessel and a first Hydrogen inlet along a second side of the Hydrogen receiver vessel, wherein the first Hydrogen inlet is coupled to the first Hydrogen outlet from the separator vessel for receiving the separated Hydrogen gas into an interior of the Hydrogen receiver vessel, wherein the emergency vent is employed to provide emergency pressure relief of the received Hydrogen gas and wherein the second Hydrogen outlet is employed for transferring the received Hydrogen gas out from the Hydrogen receiver vessel. The compressor being coupled to the second Hydrogen outlet from the Hydrogen receiver vessel. The Hydrogen storage vessel comprising a third Hydrogen outlet and a pressure safety valve on a top of the Hydrogen storage vessel and a second Hydrogen inlet on a base of the Hydrogen storage vessel, wherein the third Hydrogen outlet is coupled to one or more power systems for providing the stored Hydrogen gas to the one or more power systems to be used as fuel, wherein the pressure safety valve is employed to provide pressure relief of the stored Hydrogen gas during periods of overpressure of the stored Hydrogen gas within the Hydrogen storage vessel, wherein the second Hydrogen inlet is employed for receiving the compressed Hydrogen gas into an interior of the Hydrogen storage vessel and wherein the second Hydrogen inlet is coupled to the compressor.

In accordance with an embodiment of the invention, the system further comprises a pellet storage tank having a second pellet inlet on a top of the pellet storage tank for receiving the plurality of pellets and a pellet outlet on a base of the pellet storage tank, wherein the first pellet inlet of the reactor vessel is optionally coupled to the pellet outlet from the pellet storage tank for transferring the plurality of pellets from the pellet storage tank to the reactor vessel.

In accordance with an embodiment of the invention, the one or more power systems are of the group comprising one or more industrial power systems, one or more commercial power systems, one or more residential power systems, one or more generators and one or more vehicle charging systems.

In accordance with an embodiment of the invention, the system further comprises a cooler for cooling the compressed Hydrogen gas, the cooler coupled to the compressor.

In accordance with an embodiment of the invention, the reactor vessel contains a first sensor for reading a level of the pellet and water solution contained within the reactor vessel.

In accordance with an embodiment of the invention, the first sensor is further coupled to an alarm for sending an alert when the reactor vessel is beyond a previously defined threshold.

In accordance with an embodiment of the invention, the first sensor is further coupled to a control switch for automatically locking the first pellet inlet for preventing further deployment of additional pellets into the reactor vessel.

In accordance with an embodiment of the invention, the first sensor is further coupled to a control switch for automatically locking the water inlet for preventing further deployment of additional water into the reactor vessel.

In accordance with an embodiment of the invention, the reactor vessel contains an anti-splash plate to prevent falsely triggering an alert from the first sensor as the plurality of pellets are dispensed into the water within the reactor vessel.

In accordance with an embodiment of the invention, the reactor vessel contains a second sensor for reading a level of the pellet and water solution contained within the reactor vessel.

In accordance with an embodiment of the invention, the second sensor is further coupled to an alarm for sending an alert when the reactor vessel is below a previously defined threshold.

In accordance with an embodiment of the invention, the second sensor is further coupled to a control switch for automatically unlocking the pellet inlet for allowing further deployment of additional pellets into the reactor vessel.

In accordance with an embodiment of the invention, the second sensor is further coupled to a control switch for automatically unlocking the water inlet for allowing further deployment of additional water into the reactor vessel.

In accordance with an embodiment of the invention, the one or more of the reactor vessel, the separator vessel, the Hydrogen receiver vessel and the Hydrogen storage vessel contain a cleanout for providing access to the interior for cleaning and maintenance.

In accordance with an embodiment of the invention, one or more of the pellet storage tank and the reactor vessel contain one or more control valves for controlling flow of the plurality of pellets.

In accordance with an embodiment of the invention, one or more of the water inlet and the reactor vessel contain one or more control valves for controlling flow of the water.

In accordance with an embodiment of the invention, the water inlet contains a water treatment device for filtering out impurities prior to entering the reactor vessel.

In accordance with an embodiment of the invention, the water inlet contains a heating device for heating the water prior to entering the reactor vessel.

In accordance with an embodiment of the invention, the plurality of pellets are water soluble nanoparticle pellets composed of a substance chemically disposed to release the Hydrogen gas.

In accordance with an embodiment of the invention, the nanoparticle pellets are perforated for introducing more surface area for the Hydrogen gas to propagate.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

In the figures, embodiments are illustrated by way of example. It is to be expressly understood that the description and figures are only for the purpose of illustration and as an aid to understanding.

Embodiments will now be described, by way of example only, with reference to the attached figures, wherein the figures:

FIG. 1 illustrates a high-level view of a Hydrogen gas production and conversion system, in accordance with one embodiment.

FIG. 2 illustrates a front view of a Hydrogen gas production and conversion system, in accordance with one embodiment.

FIG. 3 illustrates a front view of a Hydrogen gas production and conversion system, in accordance with one embodiment.

FIG. 4 illustrates a front view of a Hydrogen gas production and conversion system, in accordance with one embodiment.

FIG. 5 illustrates a front view of a Hydrogen gas production and conversion system, in accordance with one embodiment.

FIG. 6 illustrates a front view of a Hydrogen gas production and conversion system, in accordance with one embodiment.

### DETAILED DESCRIPTION

The details of one or more embodiments of the subject matter of this specification are set forth in the accompanying drawings and the description below. Other features, aspects, and advantages of the subject matter will become apparent from the description, the drawings, and the claims.

Like reference numbers and designations in the various drawings indicate like elements.

The present invention provides a system of Hydrogen gas production, storage and distribution into industrial, commercial and residential power systems that may be used with many different embodiments. As such, the general purpose of the present invention, which will be described subsequently in greater detail, is to provide a new and improved Hydrogen gas production and conversion system for providing on demand energy generation from non-greenhouse gas emitting energy resources, which provides the advantages and overcomes the aforementioned disadvantages.

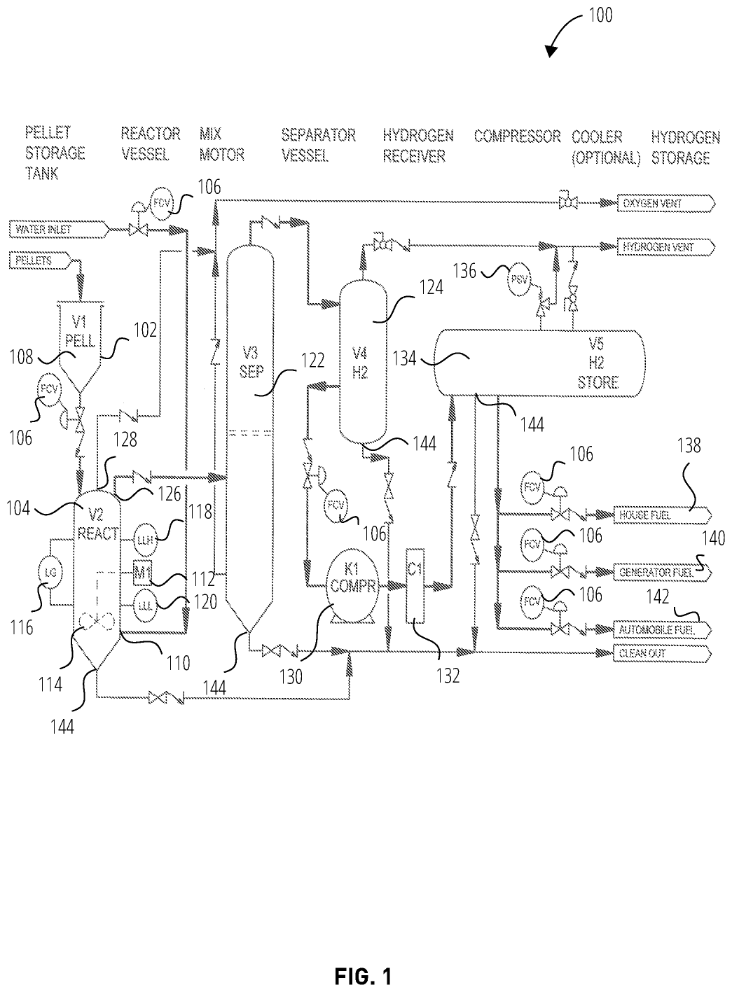

FIG. 1 illustrates a high-level view 100 of a Hydrogen gas production, storage and conversion system, according to some embodiments. In the embodiment shown, a pellet storage tank 102 is shown coupled to a reactor vessel 104 via a flow control valve 106, which controls the flows of pellets 108 from the pellet storage tank 102 to the reactor vessel 104. A water inlet 110 is shown, which is some embodiments may be coupled to a water heater for increasing the efficiency of the Hydrogen propagation in the reactor vessel 104. In some embodiments, the water heater is a commercial hot water heater. The water heater is further coupled to the reactor vessel 104 for delivering the water required for the pellet 108 and water solution. The reactor vessel 104 is shown comprising a mix motor 112 coupled to an impeller 114 and a level gauge 116 coupled to a liquid high level alarm and switch 118 and a liquid low level alarm and switch 120.

The Hydrogen and Oxygen gases produced in the reactor vessel 104 are vented to a separator vessel 122, which separates the Hydrogen gas from the Oxygen gas. The Oxygen gas is vented out of the system through the Oxygen vent 126 and released into the exterior of the system while the Hydrogen gas is vented into the Hydrogen receiver vessel 124. From the Hydrogen receiver vessel 124, the Hydrogen gas may be vented out from the system through the Hydrogen vent 128 or to a compressor 130 via a flow control valve 106 in order for the Hydrogen gas to be compressed. The compressed Hydrogen gas is then vented to a cooler 132 for additional cooling of the compressed Hydrogen gas. The compressed Hydrogen gas is then vented to a Hydrogen storage vessel 134 where the Hydrogen gas may be vented out from the system to the Hydrogen vent 128 via a pressure safety valve 136 or sent to one or more power systems via one or more flow control valves 106. For example, the Hydrogen gas may be utilized as house fuel 138 in residential power systems, generator fuel 140 in industrial and commercial power systems such as a turbine fueled by Hydrogen gas for the generation of electricity, automobile fuel 142 in vehicular systems, and any other power systems known in the art.

The reactor vessel 104, the separator vessel 122, the Hydrogen receiver vessel 124 and the Hydrogen storage vessel 134 each comprise a clean out 144 which may be coupled to expel any unwanted contents from each apparatus such as any remaining sediment from the pellets 108. The Hydrogen production and conversion system is a standalone system in that no additional energy input is required; the pellets 108 are combined with the water and mixed to produce Hydrogen gas which is stored and readily available for distribution to one or more power systems through non-greenhouse gas emitting energy resources.

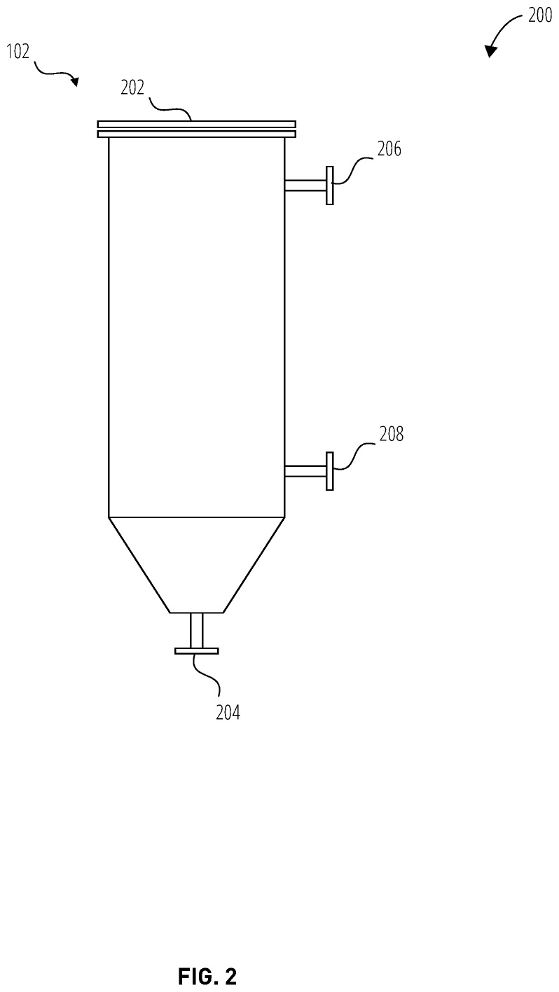

FIG. 2 illustrates a front view 200 of a pellet storage tank 102 from the Hydrogen gas production, storage and conversion system, according to some embodiments. The pellet storage tank 102 is shown having a pellet inlet 202 on the top of the pellet storage tank 102, a pellet outlet 204 on the base of the pellet storage tank 102, a first sensor 206 just below the pellet inlet 202 along the side of the pellet storage tank 102 and a second sensor 208 just above the pellet outlet 204 along the pellet storage tank 102.

The pellet inlet 202 is shown with a cover and acts as an inlet for receiving pellets 108 into the interior of the pellet storage tank 102. In some embodiments, the pellets 108 are nano-particle pellets. In some embodiments, the pellets 108 are perforated such that they become coarse or may be dimpled similar to that of a golf ball which introduces more surface area for the Hydrogen gas to propagate. In some embodiments, the pellets 108 are greater than 0.001 micrometer and smaller than 0.1 micrometer to promote a high level of Hydrogen propagation as Hydrogen propagation is dependent on crystalline size. In some embodiments, the pellets 108 are water soluble pellets. In some embodiments, the pellets 108 are in wafer form.

The pellets 108 may be composed of silicon or any substance including metals which are chemically disposed to release Hydrogen gas. In some embodiments, the pellets 108 are engineered to be able to release Hydrogen gas from sea or tap water. In some embodiments, a catalyst is added to increase the PH levels for impure water. In some embodiments, heat is added to the system to enhance the reactions, such as superheated water. Factors such as the temperature of the solution, flow rate of the water, the surface area of the pellets 108, the pressure of the solution and the volume of the pellets 108 are contributing factors to the efficiency and efficacy of the Hydrogen gas production, storage and conversion into electrical energy processes.

Once the pellets 108 are fed through the pellet inlet 202, the pellets 108 enter the interior of the pellet storage tank 102 and drop towards the pellet outlet 204 of the pellet storage tank 102 via gravity. The pellet outlet 204 acts as a channel for dispensing the pellets 108 stored in the pellet storage tank 102 into a reactor vessel 104.

The first sensor 206 is coupled to a level gauge for reading the level of the pellets 108 contained within the pellet storage tank 102. In some embodiments, the first sensor 206 is further coupled to an alarm for sending an alert when the pellet storage tank 102 is beyond a previously defined threshold or is full. In some embodiments, the first sensor 206 is further coupled to a control switch for automatically locking the pellet inlet 202, preventing further deployment of additional pellets 108 into the pellet storage tank 102.

The second sensor 208 is coupled to a level gauge for reading the level of the pellets 108 contained within the pellet storage tank 102. In some embodiments, the second sensor 208 is further coupled to an alarm for sending an alert when the pellet storage tank 102 is below a previously defined threshold, is nearing empty or is empty. In some embodiments, the second sensor 208 is further coupled to a control switch for automatically unlocking the pellet inlet 202, allowing for further deployment of additional pellets 108 into the pellet storage tank 102.

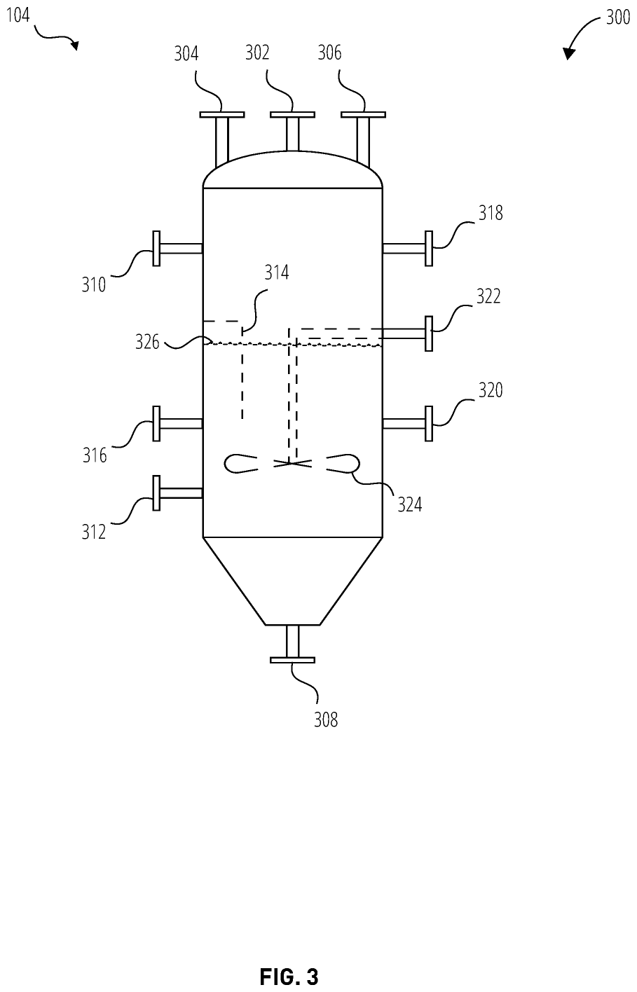

FIG. 3 illustrates a front view 300 of a reactor vessel 104 from the Hydrogen gas production, storage and conversion system, according to some embodiments. The reactor vessel 104 is shown having a Hydrogen and Oxygen outlet 302 in between a pellet inlet 304 and an alternative Oxygen outlet 306 on the top of the reactor vessel 104, a cleanout 308 on the base of the reactor vessel 104, a first sensor 310 just below the pellet inlet 304 along the side of the reactor vessel 104, a water inlet 312 just above the cleanout 308 along the side of the reactor vessel 104 on the same side as the first sensor 310, an anti-splash plate 314 at a mid-point of the interior of the reactor vessel 104 on the same side as the first sensor 310 and the water inlet 312, a second sensor 316 along the side of the reactor vessel 104 in between the anti-splash plate 314 and the water inlet 312, a first level gauge 318 just below the alternative Oxygen outlet 306 along the side of the reactor vessel 104 in plane with the first sensor 310, a second level gauge 320 just above the cleanout 308 along the side of the reactor vessel 104 on the same side as the first level gauge 318 and in plane with the second sensor 316, a motor mount with impeller shaft 322 at a mid-point of the reactor vessel 104 in between the first level gauge 318 and the second level gauge 320, and an impeller 324 within the center of the interior of the reactor vessel 104 attached to the motor mount with impeller shaft 322 and positioned below the second sensor 316 and the second level gauge 320.

The pellet inlet 304 is optionally coupled to the pellet outlet 204 from the pellet storage tank 102 allowing for transfer of the stored pellets 108 into the reactor vessel 104. Once the pellets 108 are fed from the pellet storage tank 102 to the pellet inlet 304, the pellets 108 enter the interior of the reactor vessel 104 and drop towards the cleanout 308 of the reactor vessel 104 via gravity. The pellets 108 are added to the reactor vessel 104 in order to facilitate a reaction between the pellets 108 and water contained within the reactor vessel 104 for the production of Hydrogen and Oxygen gas. The produced Hydrogen and Oxygen gases are then expelled from the reactor vessel 104 via the Hydrogen and Oxygen outlet 302 and the alternative Oxygen outlet 306. The Hydrogen and Oxygen outlet 302 is coupled to the separator vessel 122 via a ventilation system while the alternative Oxygen outlet 306 is coupled to the oxygen vent 126 via a ventilation system.

The reactor vessel 104 is optionally filled with water via the water inlet 312, which mixes with the pellets 108 with aid from the impeller 324. The water inlet 312 may be coupled to a flow meter measuring the volume of water that has been dispensed into the reactor vessel 104 and the water may be treated and/or heated prior to entering the reactor vessel 104 in some embodiments. The impeller 324 is coupled to the motor mount with impeller shaft 322 and is employed to continually agitate the pellet 108 and water solution allowing for the full use of the surface area of the pellets 108 such that the pellets 108 are exposed to as much water as possible. The cleanout 308 is employed to access the interior of the reactor vessel 104 from the base in order to clean and maintain the reactor vessel 104 and retrieve used pellets 108.

The first sensor 310 is coupled to a first level gauge 318 for reading the level of the pellet 108 and water solution contained within the reactor vessel 104. In some embodiments, the first sensor 206 is further coupled to an alarm for sending an alert when the reactor vessel 104 is beyond a previously defined threshold or is full. In some embodiments, the first sensor 310 is further coupled to a control switch for automatically locking the pellet inlet 304 and/or water inlet 312, preventing further deployment of additional pellets 108 and/or water into the reactor vessel 104. The anti-splash plate 314 is employed to prevent falsely triggering an alert from the first sensor 310 as the pellets 108 are dispensed into the water within the reactor vessel 104.

The second sensor 316 is coupled to a second level gauge 320 for reading the level of the pellet 108 and water solution contained within the reactor vessel 104. In some embodiments, the second sensor 316 is further coupled to an alarm for sending an alert when the reactor vessel 104 is below a previously defined threshold, is nearing empty or is empty. In some embodiments, the second sensor 316 is further coupled to a control switch for automatically unlocking the pellet inlet 304 and/or water inlet 312, allowing for further deployment of additional pellets 108 and/or water into the reactor vessel 104. The water level is ideally kept at the normal liquid level 326 as shown.

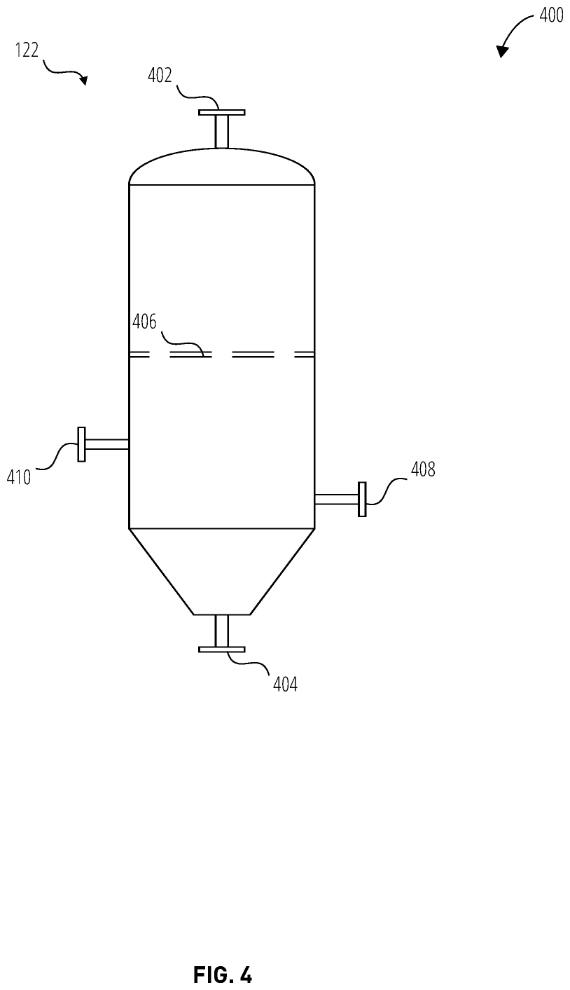

FIG. 4 illustrates a front view 400 of a separator vessel 122 from the Hydrogen gas production, storage and conversion system, according to some embodiments. The separator vessel 122 is shown having a Hydrogen outlet 402 on the top of the separator vessel 122, a cleanout 404 on the base of the separator vessel 122, a semi-permeable membrane 406 within the interior of the separator vessel 122 approximately ⅔ of the way up from the bottom of the separator vessel 122, an Oxygen outlet 408 one side of the separator vessel 122 below the semi-permeable membrane 406 and just above the cleanout 404 and a mixed gas inlet 410 on a side of the separator vessel 122 opposing the Oxygen outlet 408, below the semi-permeable membrane 406 and just above the cleanout 404.

The mixed gas inlet 410 is coupled to the Hydrogen and Oxygen outlet 302 from the reactor vessel 104 allowing for the transfer of the produced Hydrogen and Oxygen gases into the reactor vessel 104 for separation. The Hydrogen and Oxygen gases are separated within the separator vessel 122 via the semi-permeable membrane 406, which selectively allows for the passage of the Hydrogen gas while preventing the passage of the Oxygen gas. The separated Hydrogen gas is then transferred out from the separator vessel 122 to the Hydrogen receiver vessel 124 via the Hydrogen outlet 402. Similarly, the separated Oxygen gas is then vented out from the separator vessel 122 to the Hydrogen receiver vessel 124 via the Oxygen outlet 408. The cleanout 404 is employed to access the interior of the separator vessel 122 from the base in order to clean and maintain the separator vessel 122.

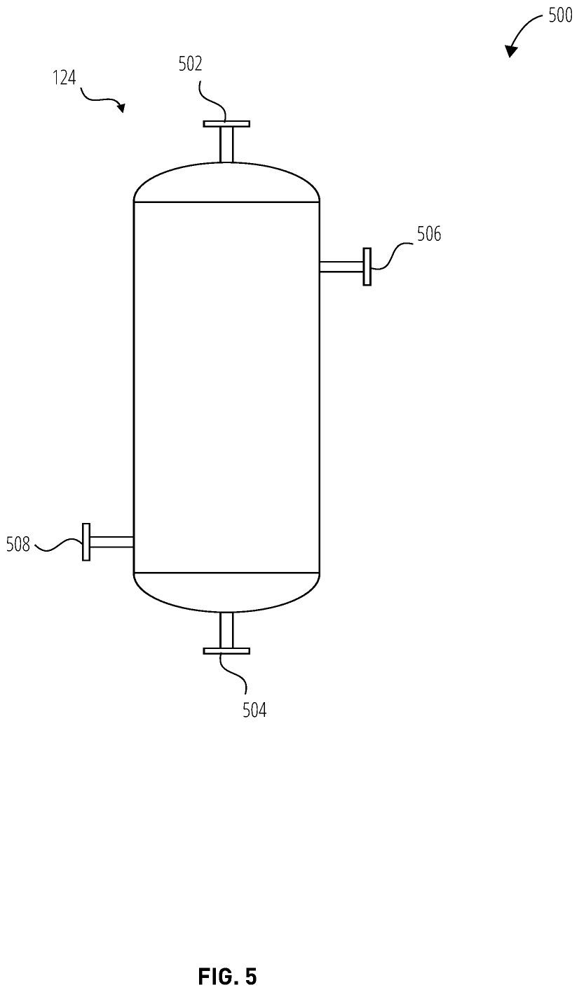

FIG. 5 illustrates a front view 500 of a Hydrogen receiver vessel 124 from the Hydrogen gas production, storage and conversion system, according to some embodiments. The Hydrogen receiver vessel 124 is shown having an emergency vent 502 on the top of the Hydrogen receiver vessel 124, a cleanout 504 on the base of the Hydrogen receiver vessel 124, a Hydrogen outlet 506 just below the emergency vent 502 along the side of the Hydrogen receiver vessel 124 and a Hydrogen inlet 508 just above the cleanout 504 along the side of the Hydrogen receiver vessel 124 opposite to the Hydrogen outlet 506.

The Hydrogen inlet 508 is coupled to the Hydrogen outlet 402 from the separator vessel 122 allowing for the transfer of the separated Hydrogen gas into the Hydrogen receiver vessel 124. The Hydrogen gas is then expelled from the Hydrogen receiver vessel 124 via the Hydrogen outlet 506 to a compressor 130 where the Hydrogen gas is compressed. The compressed hydrogen gas is then vented to the Hydrogen storage vessel 134. The Hydrogen gas is compressed in order to minimize its volume such that the Hydrogen storage vessel 134 can maximize its storage capacity as well as in order to ensure a consistent flow rate for the transportation of the Hydrogen gas between the Hydrogen receiver vessel 124 and the Hydrogen storage vessel 134. In some embodiments, the compressed Hydrogen is transferred from the compressor 130 to a cooler 132 to cool the compressed Hydrogen before being transported to the Hydrogen storage vessel 134 in order to further minimize its volume such that the Hydrogen storage vessel 134 can maximize its storage capacity.

The emergency vent 502 is employed to provide emergency pressure relief of the Hydrogen gas in case of abnormal pressure conditions, damage to the Hydrogen receiver vessel 124 or any other dangerous events involving the Hydrogen receiver vessel 124. During some of the emergency events, the Hydrogen gas within the Hydrogen receiver vessel 124 rises in temperature triggering the emergency vent 502 to prevent the Hydrogen receiver vessel 124 from rupturing due to overpressure. In some situations, the emergency vent 502 may be employed to provide relief when the Hydrogen receiver vessel 124 capacity exceeds a predetermined vent capacity threshold. The cleanout 504 is employed to access the interior of the Hydrogen receiver vessel 124 from the base in order to clean and maintain the Hydrogen receiver vessel 124.

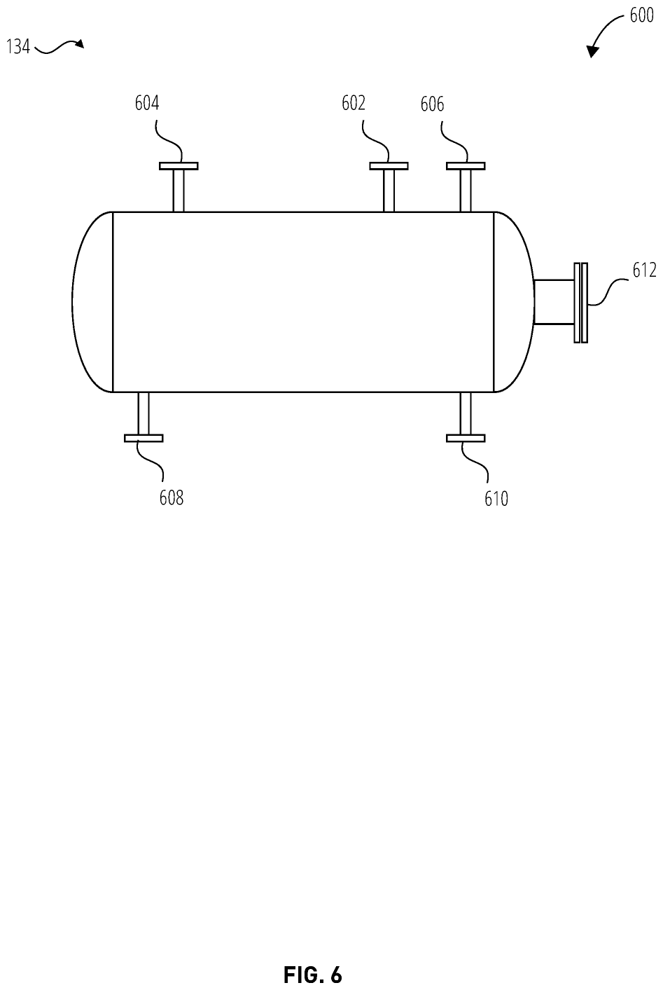

FIG. 6 illustrates a front view 600 of a Hydrogen storage vessel 134 from the Hydrogen gas production, storage and conversion system, according to some embodiments. The Hydrogen storage vessel 134 is shown having a manual vent 602 in between a Hydrogen outlet 604 and a pressure safety valve 606 on the top of the Hydrogen storage vessel 134, a Hydrogen inlet 608 and a cleanout 610 on the base of the Hydrogen storage vessel 134 where the cleanout 610 is positioned opposite to the pressure safety valve 606 and a manway 612 on the side of the Hydrogen storage vessel 134 next to the pressure safety valve 606 and the cleanout 610.

The Hydrogen inlet 608 is coupled to the compressor 130 allowing for the transfer of the compressed Hydrogen gas from the compressor 130 into the Hydrogen storage vessel 134. In some embodiments, the Hydrogen inlet 608 is coupled to the cooler 132 allowing for the transfer of the cooled, compressed Hydrogen gas from the cooler 132 into the Hydrogen storage vessel 134. The Hydrogen outlet 604 is coupled to one or more power systems to be used as fuel in power systems such as, but not limited to, industrial power systems, commercial power systems, residential power systems, generators and vehicle charging systems.

The manual vent 602 is employed to provide pressure relief of the Hydrogen gas from the Hydrogen storage vessel 134 when required. Similarly, the pressure safety valve 606 is employed to provide pressure relief of the Hydrogen gas during periods of overpressure of the Hydrogen gas within the Hydrogen storage vessel 134.

In some embodiments, the manway 612 contains one or more blind flanges. The cleanout 610 is employed to access the interior of the Hydrogen storage vessel 134 from the base in order to clean and maintain the Hydrogen storage vessel 134. Similarly, the manway 612 is employed to provide access to the interior of the Hydrogen storage vessel 134 from the base in order to enter the Hydrogen storage vessel 134 to clean and service the Hydrogen storage vessel 134.

The foregoing descriptions of specific embodiments of the present invention have been presented for purposes of illustration and description. They are not intended to be exhaustive or to limit the invention and method of use to the precise forms disclosed. Obviously, many modifications and variations are possible in light of the above teaching. As can be understood, the examples described above are intended to be exemplary only.

The embodiments described were chosen and described in order to best explain the principles of the invention and its practical application, and to thereby enable others skilled in the art to best utilize the invention and various embodiments with various modifications as are suited to the particular use contemplated. It is understood that various omissions or substitutions of equivalents are contemplated as circumstance may suggest or render expedient but is intended to cover the application or implementation without departing from the spirit or scope of the claims of the present invention.

The term “connected”, “attached”, “affixed” or “coupled to” may include both direct coupling (in which two elements that are coupled to each other contact each other) and indirect coupling (in which at least one additional element is located between the two elements).

As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A system for producing, storing and converting Hydrogen gas into a readily available fuel, said system comprising:
a reactor vessel for facilitating production of Hydrogen and Oxygen gas, said reactor vessel having a Hydrogen and Oxygen outlet out next to a first pellet inlet on a top of said reactor vessel, a water inlet along a side of said reactor vessel, a motor mount with impeller shaft at a mid-point of said reactor vessel and an impeller within a center of an interior of said reactor vessel attached to said motor mount with impeller shaft;
wherein said Hydrogen and Oxygen outlet is employed for transferring said produced Hydrogen and Oxygen gas out from said reactor vessel, wherein said first pellet inlet is employed for receiving a plurality of pellets into an interior of said reactor vessel, wherein said water inlet is employed for receiving water said interior of said reactor vessel and wherein said impeller coupled to said motor mount with impeller shaft is employed to continually agitate said plurality of pellets and said water;
a separator vessel for separating said produced Hydrogen and Oxygen gas, said separator vessel having a first Hydrogen outlet on a top of said separator vessel, a semi-permeable membrane within an interior of said separator vessel, an Oxygen outlet on a first side of said separator vessel below said semi-permeable membrane and a mixed gas inlet a second side of said separator vessel;
wherein said semi-permeable membrane is employed for separating said produced Hydrogen and Oxygen gas onto either side of said semi-impermeable membrane, wherein said first Hydrogen outlet is employed for transferring said separated Hydrogen gas out from said separator vessel, wherein said Oxygen outlet is employed for transferring said separated Oxygen gas out from said separator vessel, wherein said mixed gas inlet is employed for receiving said produced Hydrogen and Oxygen gas into said interior of said separator vessel and wherein said mixed gas inlet is coupled to said Hydrogen and Oxygen outlet from said reactor vessel;
a Hydrogen receiver vessel for receiving said separated Hydrogen gas, said Hydrogen receiver vessel having an emergency vent on a top of said Hydrogen receiver, a second Hydrogen outlet along a first side of said Hydrogen receiver vessel and a first Hydrogen inlet along a second side of said Hydrogen receiver vessel;
wherein said first Hydrogen inlet is coupled to said first Hydrogen outlet from said separator vessel for receiving said separated Hydrogen gas into an interior of said Hydrogen receiver vessel, wherein said emergency vent is employed to provide emergency pressure relief of said received Hydrogen gas and wherein said second Hydrogen outlet is employed for transferring said received Hydrogen gas out from said Hydrogen receiver vessel;
a compressor for compressing said received Hydrogen gas, said compressor coupled to said second Hydrogen outlet from said Hydrogen receiver vessel;
a Hydrogen storage vessel for storing said compressed Hydrogen gas, said Hydrogen storage vessel having a third Hydrogen outlet and a pressure safety valve on a top of said Hydrogen storage vessel and a second Hydrogen inlet on a base of said Hydrogen storage vessel;
wherein said third Hydrogen outlet is coupled to one or more power systems for providing said stored Hydrogen gas to said one or more power systems to be used as fuel, wherein said pressure safety valve is employed to provide pressure relief of said stored Hydrogen gas during periods of overpressure of said stored Hydrogen gas within said Hydrogen storage vessel, wherein said second Hydrogen inlet is employed for receiving said compressed Hydrogen gas into an interior of said Hydrogen storage vessel and wherein said second Hydrogen inlet is coupled to said compressor.

2. The system of claim 1, wherein said system further comprises:
a pellet storage tank having a second pellet inlet on a top of said pellet storage tank for receiving said plurality of pellets and a pellet outlet on a base of said pellet storage tank, wherein said first pellet inlet of said reactor vessel is optionally coupled to said pellet outlet from said pellet storage tank for transferring said plurality of pellets from said pellet storage tank to said reactor vessel.

3. The system of claim 1, wherein said one or more power systems are of the group comprising one or more industrial power systems, one or more commercial power systems, one or more residential power systems, one or more generators and one or more vehicle charging systems.

4. The system of claim 1, wherein said system further comprises:
a cooler for cooling said compressed Hydrogen gas, said cooler coupled to said compressor.

5. The system of claim 1, wherein said reactor vessel contains a first sensor for reading a level of said pellet and water solution contained within said reactor vessel.

6. The system of claim 5, wherein said first sensor is further coupled to an alarm for sending an alert when the reactor vessel is beyond a previously defined threshold.

7. The system of claim 6, wherein said first sensor is further coupled to a control switch for automatically locking said first pellet inlet for preventing further deployment of additional pellets into said reactor vessel.

8. The system of claim 6, wherein said first sensor is further coupled to a control switch for automatically locking said water inlet for preventing further deployment of additional water into said reactor vessel.

9. The system of claim 8, wherein said reactor vessel contains an anti-splash plate to prevent falsely triggering an alert from said first sensor as said plurality of pellets are dispensed into said water within said reactor vessel.

10. The system of claim 1, wherein said reactor vessel contains a second sensor for reading a level of said pellet and water solution contained within said reactor vessel.

11. The system of claim 10, wherein said second sensor is further coupled to an alarm for sending an alert when said reactor vessel is below a previously defined threshold.

12. The system of claim 11, wherein said second sensor is further coupled to a control switch for automatically unlocking said first pellet inlet for allowing further deployment of additional pellets into said reactor vessel.

13. The system of claim 11, wherein said second sensor is further coupled to a control switch for automatically unlocking said water inlet for allowing further deployment of additional water into said reactor vessel.

14. The system of claim 1, wherein one or more of said reactor vessel, said separator vessel, said Hydrogen receiver vessel and said Hydrogen storage vessel contain a cleanout for providing access to the interior for cleaning and maintenance.

15. The system of claim 2, wherein one or more of said pellet storage tank and said reactor vessel contain one or more control valves for controlling flow of said plurality of pellets.

16. The system of claim 1, wherein one or more of said water inlet and said reactor vessel contain one or more control valves for controlling flow of said water.

17. The system of claim 1, wherein said water inlet contains a water treatment device for filtering out impurities prior to entering said reactor vessel.

18. The system of claim 1, wherein said water inlet contains a heating device for heating said water prior to entering said reactor vessel.

19. The system of claim 1, wherein said plurality of pellets are water soluble nanoparticle pellets composed of a substance chemically disposed to release said Hydrogen gas.

20. The system of claim 19, wherein said nanoparticle pellets are perforated for introducing more surface area for said Hydrogen gas to propagate.
